(19) United States
(12) Patent Application Publication
(10) Pub. No.: US 2013/0262494 A1
(43) Pub. Date: Oct. 3, 2013

(54) SYSTEM AND METHOD OF PROVIDING SELECTED CONTENT VIA A COMPUTER NETWORK

(71) Applicants: Morten Just Petersen, Zurich (CH); Emmet Connolly, Zurich (CH)

(72) Inventors: Morten Just Petersen, Zurich (CH); Emmet Connolly, Zurich (CH)

(73) Assignee: Google Inc.

(21) Appl. No.: 13/602,942

(22) Filed: Sep. 4, 2012

Related U.S. Application Data
(60) Provisional application No. 61/618,664, filed on Mar. 30, 2012.
(60) Provisional application No. 61/618,665, filed on Jun. 11, 2012.

(51) Int. Cl. G06F 17/30

(52) U.S. Cl. 707/758; 707/E17.014

(57) ABSTRACT

Systems and methods of providing information via a computer network to a computing device are provided. A data processing system can receive information corresponding to activity of the computing device. A condition of a user of the computing device is determined from the activity of the computing device, wherein the condition is independent of user interactions with an input interface of the computing device. A set of criteria associated with content available for delivery to the computing device can be obtained from a database, and a match between the condition and at least a portion of the set of criteria can be identified. Responsive to the match, content associated with a matching portion of the set of criteria can be provided via the computer network to the computing device for display by the computing device.

### CROSS REFERENCES TO RELATED APPLICATIONS

This patent application claims the benefit of priority under 35 U.S.C. §119(e) of U.S. Provisional Patent Application No. 61/618,664, filed on Mar. 30, 2012 and U.S. Provisional Patent Application No. 61/618,665, filed on Jun. 11, 2012, each of which is hereby incorporated by reference in its entirety.

### BACKGROUND

In a networked environment such as the Internet, entities such as people or companies can provide information to devices connected to the network. The information can include advertisements or applications. Advertisers and application developers can attempt to deliver their information to customers who are likely to be interested in the information. A potential customer can access the information via a networked electronic device.

### SUMMARY OF THE INVENTION

At least one aspect is directed to a computer implemented method of providing information via a computer network to a computing device. The method receives, at a data processing system, information corresponding to activity of the computing device. The method determines, from the activity of the computing device, a condition of the computing device, wherein the condition is independent of user interactions with an input interface of the computing device. The method obtains, from a database associated with the data processing system, a set of criteria associated with content available for delivery to the computing device, and identifies a match between the condition of the and at least a portion of the set of criteria. The method provides, responsive to the match, content associated with a matching portion of the set of criteria via the computer network to the computing device for display by the computing device.

At least one aspect is directed to a system of providing information via a computer network to a computing device. The system includes a data processing system that can receive information corresponding to the activity of the computing device. The data processing system can determine, from the activity of the computing device, a condition of a user of the computing device during a time period wherein the condition is independent of user interactions with an input interface of the computing device during the time period. The data processing system can obtain, from a database associated with the data processing system, a set of criteria associated with content available for delivery to the computing device. The data processing system can identify a match between the condition and at least a portion of the set of criteria. The data processing system can provide, responsive to the match, content associated with a matching portion of the set of criteria via the computer network to the computing device for display to the user by the computing device.

At least one aspect is directed to a computer readable storage medium having instructions to provide information via a computer network to a computing device. The instructions include instructions to receive information corresponding to the activity of the computing device. The instructions also include instructions to determine, from the activity of the computing device, a condition of the computing device, wherein the condition is independent of user interactions with an input interface of the device. The instructions include instructions to obtain a set of criteria associated with content available for delivery to the computing device. The instructions include instructions to identify a match between the condition and at least a portion of the set of criteria. The instructions also include instructions to provide, responsive to the match, content associated with a matching portion of the set of criteria via the computer network to the computing device for display by the computing device.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram of an example environment to provide information via a computer network to a computing device, according to an illustrative implementation;

FIG. 2 is an example of a graphical user interface to receive criteria used to provide content to a computing device.

FIG. 3 is an example of a computing device interface configured to receive content.

FIG. 4 is a flow diagram depicting a method of providing information via a computer network to a computing device, according to an illustrative implementation; and

FIG. 5 is a block diagram illustrating a general architecture for a computer system that may be employed to implement various elements of the systems and methods described and illustrated herein, according to an illustrative implementation.

### DETAILED DESCRIPTION

Following below are more detailed descriptions of various concepts related to, and implementations of, methods, apparatuses, and systems for providing information via a computer network to a computing device. The various concepts introduced above and discussed in greater detail below may be implemented in any of numerous ways, as the described concepts are not limited to any particular manner of implementation. Examples of specific implementations and applications are provided primarily for illustrative purposes.

One implementation is directed toward providing content to an electronic device responsive to a condition of the user. The condition of the user can be identified by a data processing system in the absence of direct input from the user into the electronic device about the user's condition. For example, a data processing system can receive information about the activity of the electronic device, such as whether or not the electronic device is in motion or stationary. The data processing system can also receive information about the location of the device, as well as temporal information, such as how long the device has been in motion or stationary. From this information, and other information described further herein, the data processing system can determine a condition of the user. The data processing system can match the determined condition of the user with selection criteria received from an advertiser or other content provider. For example, an advertiser may desire to provide advertisements to users that have been stationary during a particular time of day, or for a determined period of time. Responsive to a detected match, the content (e.g., an ad) can be delivered to the device for display to the user.

The data processing system can receive criteria for content placement via a graphical interface provided by the data processing system. For example, a display of a computing device can display a graphical interface that offers criteria selections to the content provider (e.g., to select criteria based on location, motion, time, or date). The content provider can enter selected criteria, which can be received by the data processing system and evaluated to determine a match between the activity of the electronic device that is attributed to the user of the electronic device and the criteria.

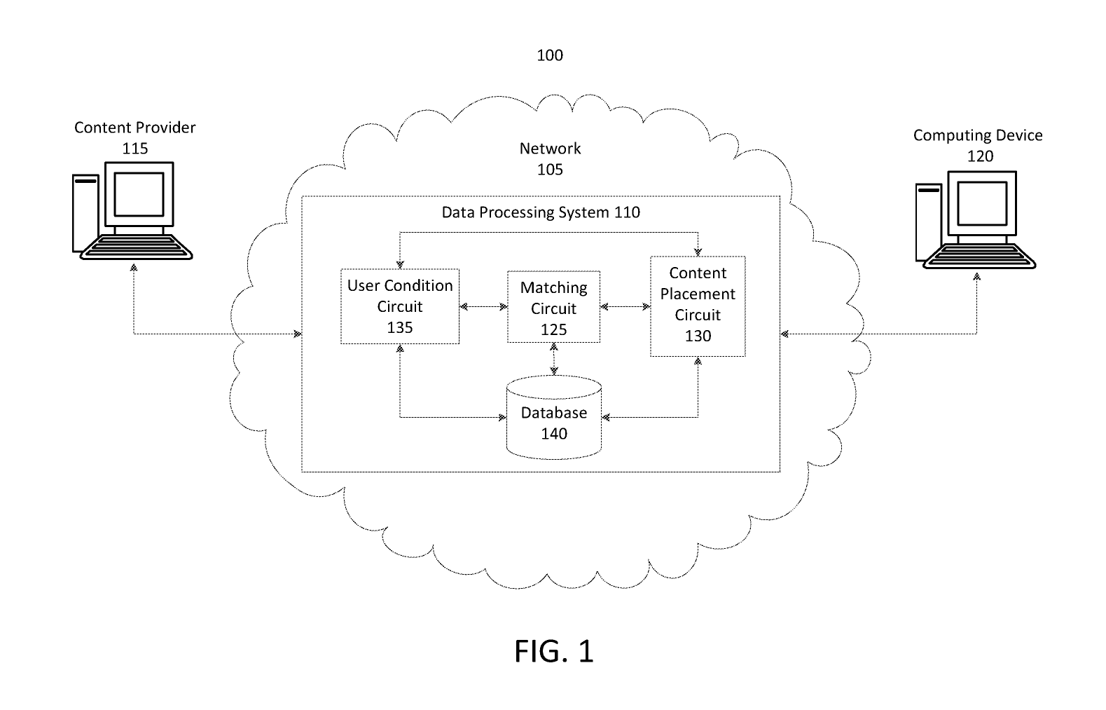

FIG. 1 illustrates an example of a system 100 for delivering content via a computer network 105 according to an implementation of the present disclosure. The network 105 can include computing networks such as the Internet, personal, local, metro, or wide area networks, intranets, and other communication networks such as mobile telephone networks. The system 100 can also include data processing system 110. The data processing system 110 can include at least one processor or logic device to communicate with at least one content provider 115, for example to receive advertisements, applications, or other information that the content provider 115 makes available for delivery via the network 105. The system 100 can also include at least one computing device 120. For example, the data processing system 110 can receive information about the computing device 120 via the network 105, and the data processing system 110 can provide content to the computing device 120 responsive to the activity of the computing device 120.

In one implementation, the data processing system 110 receives information from the computing device 120, for example via the network 105. The computing device 120 may be a server, a desktop computer, a laptop computer, a tablet computing device, a smartphone, or a television or set top box. The computing device 120 can also be a wearable electronic device, such as a wristwatch or a textile display screen integrated into an article of clothing. The information received by the data processing system 110 can correspond to the activity of the computing device 120. For example, the data processing system 110 can receive information corresponding to the location or motion of the computing device 120, the time, the sounds detected by the computing device 120, the applications running on the computing device 120, communications sent to or received by the computing device 120 (e.g. telephone calls, text messages, or emails), whether the user is manually interacting with the computing device 120, environmental conditions detected by the computing device 120 (e.g., temperature, humidity, wind speed, light, /luminescence, magnetism, available communications networks, identity of nearby devices, etc.), or other information associated with the use, activity, or lack of activity of the computing device 120.

In one implementation, the data processing system 110 can receive information from the computing device 120 during a time when the user is not interacting directly with the device. For example, the computing device 120 can be a smartphone that is stored in the pocket of the user. The data processing system 110 can receive information about the location, speed, and time of the computing device 120 with the device in the pocket of the user during a time period in which the user is not actively engaged with the computing device 120, e.g., independent of user activity with an input interface of the computing device 120. In another example, the data processing system 110 may receive information about the computing device 120 while the user is manually interacting with the device, such as by making a telephone call, sending a text message, executing an application, or otherwise actively interacting with a user interface of the computing device 120.

In one implementation, the information received by the data processing system 110 can preserve the anonymity of the user of the computing device 120. For example, the information can exclude personal details about the user. The information can also exclude device identification information, such as a serial number or historical device usage data. The activity of users on the content network 105 can be maintained in an anonymous fashion so that individuals cannot be identified from the user activity. Furthermore, the user activity information can be collected on an opt-in basis, and users can opt out of the collection of their user activity information. The user can be represented by identifiers associated with the computing device 120, for example using a cookie without regard to the actual identity of the individual person using the computing device 120. In other implementations, the information received by the data processing system 110 includes a request for content initiated by the computing device 120, but does not include information representing the user of the computing device 120.

The data processing system 110 can include logic devices such as processors, or logic circuitry such as at least one matching circuit 125, at least one content placement circuit 130, and at least one user condition circuit 135 in communication with each other and with at least one database 140. Each of the content matching circuit 125, the content placement circuit 130, and the user condition circuit 135 can include at least one processor, engine, module, or other logic device that can execute computer readable instructions. In one implementation, the data processing system 110 includes at least one server whose logic or memory devices include the content matching circuit 125, the content placement circuit 130, or the user condition circuit 135.

The user condition circuit 135 of the data processing system 110 can determine, from information received from the computing device 120, a condition of the computing device 120. For example, the computing device 120 can be a desktop computer. The data processing system 110 can receive information from the computing device 120 indicating that the computing device 120 has been interacting with the user continuously for three hours. The data processing system 110 can also receive information indicating that the time is 12:00 p.m. Based on the information received from the computing device 120, the user condition circuit 135 can determine that the user of the computing device 120 has been sitting down for at least three hours prior to 12:00 p.m. and is likely to be hungry. In this example, the user may be interfacing with the computing device 120 in a manner unrelated to the condition (e.g., hunger). For example, the user may be working or listening to music as opposed to using the computing device to make restaurant reservations or search via the network 105 for a restaurant.

In another example, the computing device 120 can be a tablet computer or smart phone. The data processing system 110 can receive information from the computing device 120 indicating that the computing device has been travelling at a speed of 100 miles per hour for 15 minutes. From this information the user condition circuit 135 can determine that the computing device 120 (and the user) is likely on a train. In this example, the data processing system 110 can also receive location information from the computing device 120, and can deduce the destination of the computing device 120 (and the user) based on the direction and velocity of the computing device.

The user condition circuit 135 can communicate with the database 140. For example, after receiving information from the computing device 120 and determining a condition of a user, the user condition circuit 135 can store the information corresponding to a condition of the computing device 120, which can be the same as or attributable to a condition of the user, in the database 140. In another example, the user condition circuit 125 can transmit the user condition information to the matching circuit 125.

In one implementation, the data processing system 110 receives information from the content provider 115, for example via the network 105. The content provider 115 can be a computing device operated by a person, a merchant, or a representative of a company to provide information to the data processing system 110. For example, the content provider 115 may provide information including advertisements or applications to the data processing system 110 for display on the computing device 120 via the network 105.

The data processing system 110 can store the information received from the content provider 115 (e.g., advertisements, applications, or criteria for displaying content) in the database 140. In one implementation, the data processing system 110 determines a condition of the computing device 120 based on the activity of the computing device 120. The condition of the computing device 120 can be any characteristic that may be useful for allowing the content provider 115 to select content for display by the computing device 120 to the user including, for example, any information related to the activity or status of the computing device 120. For example, the data processing system 110 can determine the location of a user based on the location of the computing device 120.

The condition of the computing device 120 can include any status, condition or event detected by the computing device 120. For example, the computing device can detect environmental conditions such as temperature, humidity, wind speed or direction, or other conditions such as time, light, luminescence, magnetism, available communication networks, or the existence or identify of other computing devices within a distance or range of the computing device 120. The data processing system 110 can receive the condition of the computing device 120 via the network 105. The condition of the computing device 120 can also identify the type of device that the computing device 120 is. For example, the data processing system 110 can obtain an indication that the computing device 120 is a smart phone, tablet, personal digital assistant, television, communication device, laptop computer, or desktop computer. In some implementations, the condition of the computing device 120 indicates a brand or manufacturer of the computing device, or a communications network used by the computing device 120.

The information received by the data processing system 105 from the content provider 115 via the network 105 can also include criteria indicating a time period to display the content to a user of the computing device 120. For example, the content provider may be the owner of a lunch restaurant attempting to advertise to people who are likely to be hungry. In this example, the content provider 115 can indicate that their advertisement should be displayed between the hours of 11:00 a.m. and 2:00 p.m. to computing devices 120 associated with users who have been sitting down for more than 2 hours. In other examples, a content provider 115 may indicate that their content should be displayed at computing devices 120 that are located in a specified geographic region, traveling by a specified mode of transportation, or exposed to specified sounds. The criteria selected by the content provider 115 may be selected for computing devices 120 associated with users determined to have an interest in the content.

Thus, in one implementation, the data processing system 100 receives information from the content provider 115 that includes at least one criterion for when the content should be delivered. The content provider 115 may indicate that content should be delivered only if a combination of criteria are met simultaneously, or may indicate several alternative sets of criteria for delivering content. For example, the information received by the data processing system 110 may indicate that the content provider 115 wishes to display their content at computing devices 120 that are located in a specified city and that are traveling by train. Alternatively, the content provider 115 may indicate that the content should be displayed at computing devices 120 associated with users who are determined to be sitting down or walking. These criteria can be selections received by the data processing system 110 and stored in the database 140.

The matching circuit 125 can determine when the computing device 120 (or associated user) meets the criteria received from the content provider 115. For example, the matching circuit 125 can receive criteria information directly from the content provider 115. In another example, the matching circuit 125 can retrieve the criteria from the content provider 115 by accessing it in the database 140. Similarly, the matching circuit 125 can access the user condition information by receiving it directly from the user condition circuit 135 or by accessing it in the database 140. The matching circuit 125 can compare the criteria specified by the content provider 115 to the user condition determined by the user condition circuit 135 to determine whether there is a match.

In one implementation, the matching circuit 125 may identify a match when the computing device 120 meets or satisfies at least a portion of the criteria from the content provider 115 based on information about the computing device 120. For example, a content provider 115 may indicate that content should be displayed to users who are travelling by train in a defined geographic location, such as a particular city or country. In this example, the matching circuit 125 can identify a match by determining that a user is travelling by train in Germany, and will not identify a match with a user who is travelling by train in a different country, or who is in Germany but is not travelling by train.

In another implementation, the matching circuit 125 can identify a match based on a subset of the criteria provided by the content provider 115. For example, the content provider 115 can indicate that the content is appropriate for display on computing devices 120 to users who are walking in San Francisco between 4 p.m. and 6 p.m. The matching circuit 125 can identify a partial match when a user (or their computing device 120) meets a subset of the criteria, such as a computing device 120 of a user who is travelling by car in San Francisco between 4 p.m. and 6 p.m. The partial match may be identified by the data processing system 110 as a match sufficient to provide content from the content provider 115 for display at the computing device 120.

The content placement circuit 130 can respond to the match or partial match identified by the matching circuit 125 by delivering the relevant content to the computing device 120 for display to the user. For example, the content matching circuit 125 determines a match between a condition of the computing device 120 and the criteria specified by content provider 115. Responsive to the match, the content placement circuit 130 can access the content associated with the criteria and deliver it to the computing device 120. In one implementation, the content placement circuit 130 can be alerted of a match by communicating directly with the matching circuit 125. In another implementation, the content placement circuit 130 can discover that a match has occurred by retrieving the match information from the database 140, after the matching circuit 125 has stored the match information in the database 140. The content placement circuit 130 can access the content to be delivered to the computing device 120 by retrieving it from the database 140, or can instruct the content provider 115 to provide the content to the computing device 120 via the network 105. The content placement circuit 130 can deliver or provide instructions to deliver the content to the computing device 120 via the network 105.

For example, the content provider 115 may be a restaurant attempting to reach computing devices 120 associated with users who are located within a specified distance (e.g., 4 miles) of the restaurant during a specified time period (e.g., between the hours of 5 p.m. and 7 p.m.). The matching circuit 125 can detect computing devices 120 that meet or partially meet the location and time criteria specified by the content provider 115. The content placement circuit 130 can respond to this match by delivering the content to the computing devices 120 for display to the users who satisfy the criteria. In this example, the content placement circuit 130 can access the restaurant's advertising content and deliver the content via the network 105 to computers, mobile phones, tablets, or televisions of users who match the time and location criteria, as determined by the content matching circuit 125. In this example, the data processing system 110 does not receive information input from the users into the computing devices 120 that indicates the condition (e.g., hunger) of the users. Rather, the data processing system 110 determines this information during a time period in which the users do not manually interface with the computing device 120 to indicate that they are hungry. The users may access the computing device 120 for other reasons during this time period. Thus, the condition of the computing device 120 can be independent of user interactions with an input interface of the computing device 120. For example, the user may not interact with the input interface (e.g., a touchscreen) of the computing device during a time period when the condition is determined, or may interact with the input interface in a manner unrelated to the condition, such as by making an unrelated phone call.

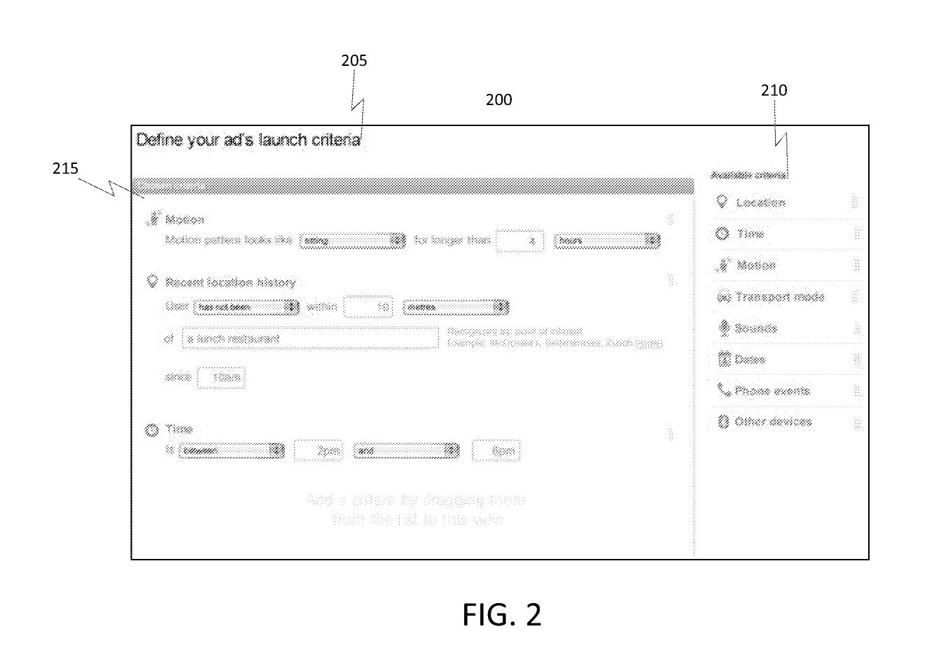

FIG. 2 illustrates an example of a graphical user interface 200 to receive criteria used to provide content to a computing device according to an implementation of the present disclosure. The graphical user interface 200 can be provided by the data processing system 110 via the network 105 for display to the content provider 115. The graphical user interface 200 can be displayed to the content provider 115 on a computing device, for example as a webpage.

In some implementations, the graphical user interface 200 can include a title 205, which can indicate to the content provider 115 that the graphical user interface 200 can be used to define the criteria for displaying content on the computing device 120. The graphical user interface 200 can also include an available criteria list 210. The available criteria list 210 can display to the content provider 115 a list of criteria that can be chosen to select content for display to a user of computing device 120. For example, the available criteria list 210 can contain items corresponding to criteria such as location, time, motion, transport mode, sounds, dates, phone events, or other criteria items. It will be understood, however, that other criteria not listed in list 210 may instead or in addition be available to a content provider.

In some implementations, an item in the available criteria list 210 may be represented as a hyperlink, and the content provider 115 can select a criteria item by clicking on its hyperlink. The graphical user interface 200 can also include a chosen criteria space 215. In this example, the graphical user interface 200 can respond to the selection of a criteria item by the content provider 115 by displaying the selected criteria item in the chosen criteria space 215 with prompts to the content provider 115 for additional information corresponding to the available criteria of the criteria list 210 selected by the content provider 115. In another implementation, an item in the available criteria list 210 can be represented as a movable object. In this example, the content provider 115 can choose a criteria item by selecting it with a pointing device (e.g. using a mouse) and dragging it from the available criteria list 210 onto the chosen criteria space 215.

The chosen criteria space 215 can display the criteria that have been selected by the content provider 115. Any number of criteria items can be displayed in the chosen criteria space 215. In some implementations, a criteria item selected from the criteria list 210 and entered into the criteria space 215 can expand in the criteria space 215 to display further options responsive to being selected by the content provider 115 and added to the chosen criteria space 215. For example, the content provider 115 can select the criteria item corresponding to motion from the available criteria list 210. The selected item (e.g., motion) can be displayed in the chosen criteria space 215. The motion criteria can expand in the chosen criteria space 215 to display additional options, such as the type of motion (e.g., sitting, standing, walking, etc.) and the duration of time that the user has been engaged in such motion (e.g. longer than 4 hours, or less than 4 hours). The graphical user interface 200 can include input or display interfaces, and can provide text boxes, drop-down menus, or other input interfaces to allow the content provider 115 to specify additional options for an expanded item in the chosen criteria space 215. In this example, the content provider 115 can be a restaurant owner seeking to advertise to users who are likely to be hungry by directing an advertisement to computing devices 120 associated with users who have been in transit (e.g., walking) for a period of time (e.g., more than 40 minutes).

It is appreciated that the user interface 200 is an example, and other user interfaces can be provided to obtain a selection of criteria items. For example, the user interface 200 can allow multiple criteria items to be selected from the criteria list 210 to define criteria used for selecting content to display on the computing device 120. For example, the content provider 115 can select a running criterion or a walking criterion, (or both,) together with a time criterion, as criteria types from the criteria list 210. In some implementations, a single criteria type or category can include multiple criteria items. For example, a motion criterion can include running, walking, or vehicular transport criteria, associated with the same or different additional criteria, such as a first time criterion for walking, (e.g., a time period of 40 minutes) and a second time criterion for running (e.g., a tine period of 25 minutes).

In another example, the content provider 115 can select the criteria item corresponding to location from the available criteria list 210. The location item can be displayed in the chosen criteria space 215. The location criteria can expand in the chosen criteria space 215 to display additional options, such as the type of location (e.g., a lunch restaurant), a distance from the location (e.g. 10 meters), and a minimum or maximum duration of time during which the user has been within the specified distance of the location. The location criteria can also allow the content provider 115 to provide content to computing devices 120 for display to users who have not been within the specified location, while excluding users who have. In some implementations, the location may be a broad geographic region, such as a city, a state, or a country. In other implementations, the location may be defined narrowly, such as a building or a location specified by coordinates on a map. In one example, the content provider 115 can be a business owner interested in advertising to users who have been within 100 feet of a competitor's location, but who have not been within 100 feet of the business owner's location. The graphical user interface 200 can provide text boxes, drop-down menus, or other input methods to allow the content provider 115 to specify additional options for the location item in the chosen criteria space 215.

Information received from a computing device 120 can be collected on an anonymized basis such that information is received without regard to the identity of the user of the computing device 120. For example, the information received can be represented by a cookie data file that does not identify the user. A user can affirmatively opt-in in order for information to be received about the computing device 120, and can opt-out to prevent the collection of information about the computing device 120. A user can also to restrict the information that is received from the computing device 120. For example, a user may allow the data processing system 110 to receive information about the motion of the computing device 120, but may not permit the data processing system 110 to receive location information from the computing device 120. In another example, the user may allow some location information to be collected, but may limit the accuracy or resolution of the information. The user may allow the computing device 120 to identify the country, state, city or region in which the computing device 120 is located, but not permit the computing device 120 to provide pinpoint street level data identifying the precise location of the computing device 120.

The accuracy and precision of the information received by the data processing system 110 may be limited by the capabilities of the computing device 120 or the network 105. For example, some computing devices 120 may have the ability to transmit highly accurate GPS location information to the data processing system 110, while other devices may rely on less accurate cellular tower triangulation to determine location. A content provider 115 who specifies a narrow range of locations (e.g., a range that can be measured by GPS data but cannot be measured by cellular tower data) for directing content to computing devices 120 may be restricted from directing content to computing devices 120 that are incapable of measuring location data at the specified precision level.

In some implementations, the data processing system 110 obtains a rough estimate of location of the computing device 120 corresponding for example to a cell phone tower closest to or in communication with the computing device. In this example, the data processing system 110 can prompt the computing device 120 for more detailed location information, such as a street where the computing device 120 is located, or a point of origin or destination of the computing device 120. The data processing system 110 can also interpolate or estimate a more precise location based on a rough location. For example, the data processing system 110 can obtain data that the communication device is within communication range of an identified cell phone tower that is in a rural area, and that a highway passes through this area. From this information, the data processing system 110 can determine that the computing device 120 is on the highway on that rural area.

In other implementations, the content provider 115 can select the criteria item corresponding to transport mode from the available criteria list 210. The transport mode item can be displayed in the chosen criteria space 215. The transport mode criteria can expand in the chosen criteria space 215 to display additional options, such as the type of transport mode (e.g., walking, bicycling, driving, etc.) and a minimum or maximum duration of time during which the user has been within the specified distance of the location. For example, the content provider 115 can be an owner of a railroad, and can deliver map or schedule content for a train to users who are travelling by rail. The graphical user interface 200 can provide text boxes, drop-down menus, or other input methods to allow the content provider 115 to specify additional options for the location item in the chosen criteria space 215.

A content provider 115 can attempt to identify computing devices 120 by selecting a criteria item from the available criteria list 210 more than one time. For example, a restaurant owner can identify computing devices 120 by specifying at least two separate time criteria (e.g., a time corresponding to lunch hours, and a time corresponding to dinner hours). In another example, a retailer who operates stores in multiple (e.g., five) locations can select the location item once for each store (e.g., five times), with each location item corresponding to the location of a different store. The graphical user interface 200 can receive the content and the selection criteria from the content provider 115. The data processing system 110 can receive the selection criteria and associated content that was entered into the graphical user interface 200 via the network 105. In this example, the matching circuit 125 can use the received information to determine a match with the computing device 120. When a match or partial match between the selection criteria and the condition of the computing device 120 is determined, the same or different content can be provided to the computing device 120. For example, different content can be provided for each of the different (e.g., five) locations of the retail store in the above example. Thus, the content provider 115 can provide customized conditions for different content items.

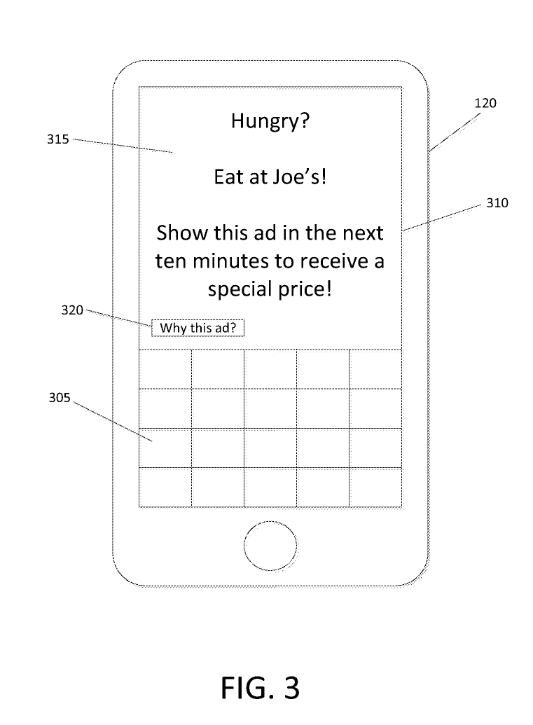

FIG. 3 depicts a computing device 120 configured to display content. The computing device 120 can be a tablet, a smartphone, a personal digital assistant, a desktop computer, a laptop computer, a television, or any other kind of computing device capable of displaying content. The computing device 120 can include an input interface 305. In some implementations, the input interface 305 can be a physical keyboard provided as part of the computing device 120. In other implementations, the input interface 305 can be part of a representation of a keyboard on a touchscreen interface of the computing device 120. The input interface 305 can also be a separate device, such as a keyboard or pointing device that is in communication with the computing device 120.

The computing device 120 can also include a display area 310. For example, the display area 310 can be an LCD or OLED screen configured to allow a user of the computing device 120 to view content. In some implementations, the display area 310 may include the input interface 305 (e.g., the input interface 305 can be a representation of a keyboard that occupies a portion of the display area 310). In some implementations, the display area 310 can occupy a relatively large portion of a surface of the computing device 120 (e.g., greater than 90%).

The display area 310 can be used to show content 315. For example, the content 315 can be content received from the content provider 115 of FIG. 1. As depicted in FIG. 3, the content can be an advertisement directed to a user of the computing device 120 to alert the user of a nearby business, e.g., Joe's restaurant. The content can be provided responsive to the condition of the computing device 120 or a determined condition of a user of the computing device 120.

The display area 310 can also include an informational prompt 320. In some implementations, the informational prompt can be a hyperlink that is selectable by the user of the computing device 120 to reveal additional information about the content 315. For example, the informational prompt 320 can offer an explanation as to why the content 315 appears in the display area 310. The user can select the informational prompt 320 using input interface 305 to learn the reason that the content 315 is displayed on the computing device 120. For example, selecting the informational prompt 320 can cause the display area 310 to display the criteria that were satisfied to cause the content 315 to be delivered to computing device 120. In this example, the criteria can be a location (e.g., the computing device 120 is located within one mile of Joe's restaurant) and time (e.g., it is lunchtime when the content 315 is delivered).

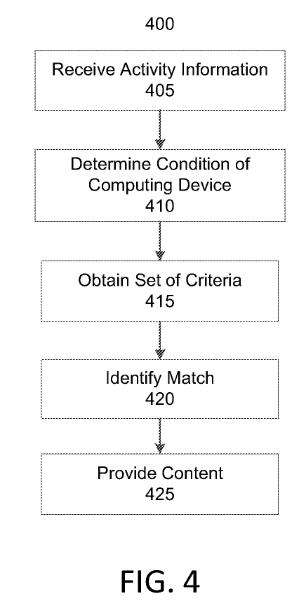

FIG. 4 illustrates a flow diagram depicting a method 400 of providing information via a computer network to a computing device. The method 400 can receive information about the activity of a computing device (BLOCK 405). In one implementation, the method 400 includes a data processing system to receive (BLOCK 405) the activity information from the computing device. The received activity information can include information about the motion, location, or time of the computing device, or contextual information about the user of the computing device or the computing device itself. The activity information can be received by the data processing system via a network. The computing device that receives the activity information can include a server, a desktop computer, a laptop computer, a tablet computing device, a smartphone, or a television or set top box. The information can be received (BLOCK 405) from the computing device in a manner that preserves the anonymity of the user of the computing device (e.g. by excluding personal identification information of the user such as the user's name or historical usage data for the computing device). In some implementations, information can be processed before it is received (BLOCK 405) from the computing device. For example, the computing device may periodically its location in terms of GPS coordinates. The computing device may use this location information to calculate its speed over a period of time, and may report this calculated speed to the data processing system. In other implementations, the information received (BLOCK 405) may be the raw GPS coordinate data, and the data processing system may use the raw data to calculate other information, such as the speed of the computing device.

The method 400 can also determine a condition of the computing device (BLOCK 410), based for example on the received activity information of the computing device. The determined condition of the computing device, which may be attributable to a user of the computing device, can indicate the user's motion, transport mode, location, or time for example. In some implementations, the method 400 determines a condition of the computing device attributable to the user (BLOCK 410) while the user is not manually interacting with the computing device. For example, the method 400 could determine that a user of a computing device is travelling by car based on activity information indicating that the computing device is travelling 45 miles per hour. In another example, the method 400 could determine that the user of a computing device is hungry if the activity of the computing device shows that it has been travelling around a city for a determined time period (e.g., several hours) and has not been located inside a restaurant during that time period.

The method 400 can obtain a set of criteria for providing content to a computing device (BLOCK 415). The set of criteria can be obtained (BLOCK 415) from a database associated with the data processing system. The obtained set of criteria can include, for example, location criteria, motion criteria, transport mode criteria, time criteria, sound criteria, or criteria related to any other condition that can be detected by the device. In one example, the obtained criteria are received by the data processing system from a content provider. The content provider may select criteria based on the users who are likely to be interested in the content. For example, a business owner can attempt to direct content to nearby consumers by selecting location criteria corresponding to the location of the business. In one implementation, the method can provide a graphical user interface to the content provider. The content provider can enter the set of criteria into the graphical user interface to be delivered to the data processing system and stored in the database.

The method 400 can also identify a match between the condition of the user and the criteria (BLOCK 420). In some implementations, the method 400 includes a matching circuit for determining a match. To identify a match (BLOCK 420), the matching circuit can compare the determined condition (BLOCK 410) with the obtained set of criteria (BLOCK 415). For example, the matching circuit can determine that a user of a computing device matches the criteria specified by the content provider. The method 400 can identify match (BLOCK 420) based on an exact match with all criteria elements or a partial match with a portion of the criteria.

The method 400 can provide content to a computing device (BLOCK 425). In some implementations, the method includes a content placement circuit that delivers content to a computing device via a network. The content placement circuit can receive the content directly from the content provider or from a database associated with the data processing system. After a match is identified (BLOCK 420), the method 400 can respond to the match by delivering the content (BLOCK 425) associated with the match to the computing device of the user whose condition matched the criteria. In some implementations, the content can include an advertisement. Content providers can select criteria based on the characteristics of their intended consumers, and the method 400 can respond by delivering the advertising content (BLOCK 425) to computing devices of consumers determined to at least partially match the criteria. In other examples, the content can include a software program such as an application. The method 400 can determine from a user's condition that the application is relevant to the user, and can launch the application on the computing device associated with the user without, in this example, direct input from the user regarding the application.

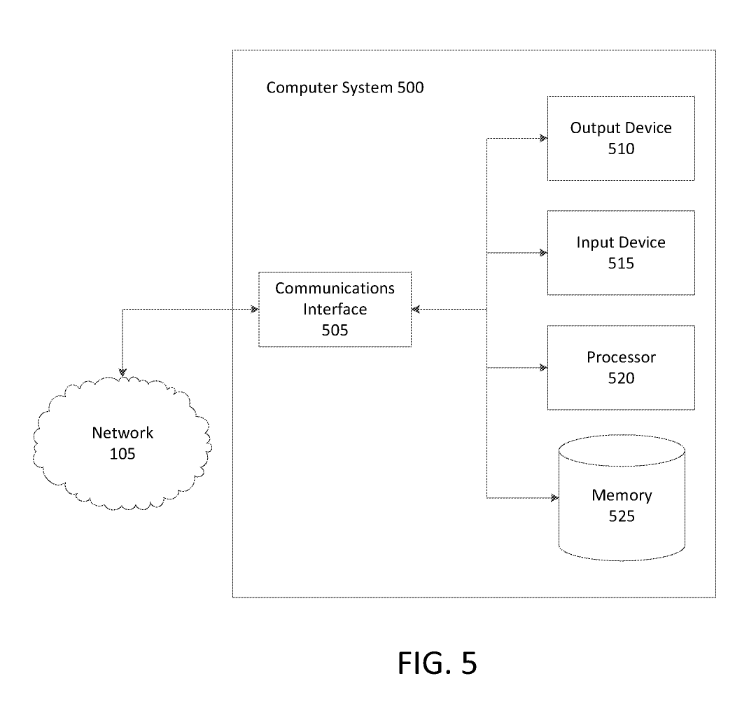

FIG. 5 shows the general architecture of an illustrative computer system 500 that may be employed to implement any of the computer systems discussed herein (including the system 100 and its components such as data processing system 110, content provider 115, or computing device 120 from FIG. 5) in accordance with some implementations. The computer system 500 of FIG. 5 comprises one or more processors 520 communicatively coupled to memory 525, one or more communications interfaces 505, and one or more output devices 510 (e.g., one or more display units) and one or more input devices 515. The processors 520 can be included in the matching circuit 125, content placement circuit 130, user condition circuit 135, or the other components of the system 100 such as the content provider 115 or computing device 120.)

In the computer system 500 of FIG. 5, the memory 525 may comprise any computer-readable storage media, and may store computer instructions such as processor-executable instructions for implementing the various functionalities described herein for respective systems, as well as any data relating thereto, generated thereby, or received via the communications interface(s) or input device(s) (if present). Referring again to the system 100 of FIG. 1, the matching circuit 125, content placement circuit 130, user condition circuit 135, and database 140 can include the memory 525 to store information corresponding to criteria from content providers, activity of computing devices, identifications of matches, and the content to be delivered. The processor(s) 520 shown in FIG. 5 may be used to execute instructions stored in the memory 525 and, in so doing, also may read from or write to the memory various information processed and or generated pursuant to execution of the instructions.

The processor 520 of the computer system 500 shown in FIG. 5 also may be communicatively coupled to or control the communications interface(s) 505 to transmit or receive various information pursuant to execution of instructions. For example, the communications interface(s) 505 may be coupled to a wired or wireless network, bus, or other communication means and may therefore allow the computer system 500 to transmit information to and/or receive information from other devices (e.g., other computer systems). While not shown explicitly in the system of FIG. 1, one or more communications interfaces facilitate information flow between the components of the system 100. In some implementations, the communications interface(s) may be configured (e.g., via various hardware components or software components) to provide a website as an access portal to at least some aspects of the computer system 500. Examples of communications interfaces 505 include user interfaces (e.g., web pages) having content (e.g., advertisements) selected by the content placement circuit 130 and provided by the content provider 115 for display on computing devices 120.

The output devices 510 of the computer system 500 shown in FIG. 5 may be provided, for example, to allow various information to be viewed or otherwise perceived in connection with execution of the instructions. The input device(s) 515 may be provided, for example, to allow a user to make manual adjustments, make selections, enter data or various other information, or interact in any of a variety of manners with the processor during execution of the instructions. Additional information relating to a general computer system architecture that may be employed for various systems discussed herein is provided at the conclusion of this disclosure.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The matching circuit 125, the content placement circuit 130, and the user condition circuit 135 can include or share one or more data processing apparatuses, computing devices, or processors.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), plasma, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 500 or system 100 can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, the matching circuit 125, the content placement circuit 130, and the user condition circuit 135 can be a single module, a logic device having one or more processing circuits, or part of a search engine.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementations, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementations or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementation,” “an alternate implementation,” “various implementation,” “one implementation” or the like are not necessarily mutually exclusive and are intended to indicate that a particular feature, structure, or characteristic described in connection with the implementations may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be implemented in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A computer implemented method of providing information via a computer network to a computing device, comprising:
receiving, at a data processing system, information corresponding to activity of the computing device;
determining, from the activity of the computing device, a condition of the computing device, wherein the condition is independent of user interactions with an input interface of the computing device;
obtaining, from a database associated with the data processing system, a set of criteria associated with content available for delivery to the computing device;
identifying a match between the condition and at least a portion of the set of criteria; and
providing, responsive to the match, content associated with a matching portion of the set of criteria via the computer network to the computing device for display by the computing device.

2. The method of claim 1, wherein the information corresponding to the activity of the computing device preserves anonymity of a user of the computing device.

3. The method of claim 1, further comprising:
receiving the set of criteria from a content provider;
storing the set of criteria in a database associated with the data processing system; and
providing the content via the computer network to the computing device for display to a user.

4. The method of claim 1, wherein the content is responsive to the condition of the computing device.

5. The method of claim 1, further comprising:
determining a request for content in an absence of direct user input into the computing device regarding the content.

6. The method of claim 1, wherein the activity of the computing device indicates at least one of motion of the computing device, a location of the computing device, a time, and a date.

7. The method of claim 1, wherein the condition of the computing device includes at least one of an indication of motion of the computing device, a transport mode of the computing device, a location of the computing device, and a time.

8. The method of claim 1, further comprising:
receiving the set of criteria from a content provider, wherein the set of criteria includes at least one of location criteria, motion criteria, time criteria, transport mode criteria, and sound criteria.

9. A system of providing information via a computer network to a computing device, comprising:
a data processing system configured to:
receive information corresponding to the activity of the computing device;
determine, from the activity of the computing device, a condition of the computing device during a time period, wherein the condition is independent of user interactions with an input interface of the computing device during the time period;
obtain, from a database associated with the data processing system, a set of criteria associated with content available for delivery to the computing device;
identify a match between the condition and at least a portion of the set of criteria; and
provide, responsive to the match, content associated with a matching portion of the set of criteria via the computer network to the computing device for display by the computing device.

10. The system of claim 9, wherein the data processing system is further configured to:
receive the set of criteria from a content provider;
store the set of criteria in the database; and
provide the content via the computer network to the computing device for display by the computing device.

11. The system of claim 9, wherein the data processing system is further configured to determine a request for content in an absence of direct user input into the computing device regarding the content.

12. The system of claim 9, wherein the data processing system is further configured to receive the set of criteria from a content provider, wherein the set of criteria includes at least one of location criteria, motion criteria, time criteria, transport mode criteria, and sound criteria.

13. A computer readable storage medium having instructions to provide information via a computer network to a computing device, the instructions comprising instructions to:
receive information corresponding to activity of the computing device;
determine, from the activity of the computing device, a condition of the computing device, wherein the condition is independent of user interactions with an input interface of the computing device;
obtain a set of criteria associated with content available for delivery to the computing device;
identify a match between the condition and at least a portion of the set of criteria; and
provide, responsive to the match, content associated with a matching portion of the set of criteria via the computer network to the computing device for display by the computing device.

14. The computer readable storage medium of claim 13, wherein the information corresponding to the activity of the computing device preserves anonymity of a user of the computing device.

15. The computer readable storage medium of claim 13, further comprising instructions to:
receive the set of criteria from a content provider;
store the set of criteria in a database; and
provide the content via the computer network to the computing device for display to a user.

16. The computer readable storage medium of claim 13, wherein the content is responsive to the condition of the computing device.

17. The computer readable storage medium of claim 13, further comprising instructions to determine a request for content in an absence of direct user input into the computing device regarding the content.

18. The computer readable storage medium of claim 13, wherein the condition of the computing device includes at least one of an indication of motion of the computing device, a transport mode of the computing device, a location of the computing device, and a time.

19. The computer readable storage medium of claim 13, further comprising instructions to receive the set of criteria from a content provider, wherein the set of criteria includes at least one of location criteria, motion criteria, time criteria, transport mode criteria, and sound criteria.

20. The computer readable storage medium of claim 13, further comprising instructions to:
display, at a first portion of a user interface of the computing device, an indication of available criteria categories;
receive, at a second portion of the user interface, an indication of criteria selected by a content provider; and
display, at a third portion of a user interface, a preview of the content.
